(19) United States
(12) Patent Application Publication
(10) Pub. No.: US 2011/0247573 A1
(43) Pub. Date: Oct. 13, 2011

(54) OXYGENATE DEHYDRATION SYSTEM FOR COMPRESSION IGNITION ENGINES

(76) Inventor: DAVID M. McCANN, Los Angeles, CA (US)

(21) Appl. No.: 12/755,591

(22) Filed: Apr. 7, 2010

(51) Int. Cl. F02B 51/02; F02B 9/02

(52) U.S. Cl. 123/3

(57) ABSTRACT

A fuel system for an automotive engine comprises a dehydration catalyst device in fluid communication with a fuel injection system and a fuel tank, wherein the fuel tank is configured to store a fuel having an oxygenate content, wherein the dehydration catalyst device is configured to receive the fuel from the fuel tank, wherein the dehydration catalyst device is configured to dehydrate at least a portion of the oxygenate content into an ether to form an output fuel, and wherein the dehydration catalyst device is configured to provide the output fuel to the fuel injection system.

### TECHNICAL FIELD

The present invention relates generally to automotive fuel systems, and more particularly, some embodiments relate to lowering the octane rating of standard automotive fuel for use in a compression ignition engine.

### DESCRIPTION OF THE RELATED ART

Compression ignition engines can potentially greatly improve the efficiency and emissions of gasoline fueled engines. In compression ignition engines, fuel injected into the engine combustion chamber auto-ignites when subject to sufficient pressure and temperature. Operation of compression ignition engines, particularly homogeneous charge compression ignition (HCCI) engines, benefit from precise control over ignition characteristics of the fuel used.

To reduce engine emissions of certain pollutants such as carbon monoxide, many jurisdictions require the addition of oxygenates into gasoline. Methyl tert-butyl ether (MTBE) was the most common oxygenate added to gasoline to meet these requirements. However, due to health concerns, it is being increasingly phased out as a gasoline additive.

Alcohols, particularly ethanol and less commonly, methanol, are now being used as the most common oxygenate. In many places, standard pump gasoline may comprise up to 10% vol. ethanol. Ethanol raises the octane rating of gasoline, thereby making it less susceptible to auto-ignition. Accordingly, standard pump gasoline comprising alcohols are more difficult to use in compression ignition engines.

### BRIEF SUMMARY OF EMBODIMENTS OF THE INVENTION

According to various embodiments of the invention, a fuel system is provided that includes a catalytic reactor that is configured to convert at least a portion of the alcohol content of standard gasoline into an ether. The resultant fuel comprises an ether-rich gasoline that has a higher cetane number (CN) than the un-treated gasoline and is therefore more auto-ignitable.

According to an embodiment of the invention, a fuel system for an automotive engine comprises a dehydration catalyst device in fluid communication with a fuel injection system and a fuel tank, wherein the fuel tank is configured to store a fuel having an oxygenate content, wherein the dehydration catalyst device is configured to receive the fuel from the fuel tank, wherein the dehydration catalyst device is configured to dehydrate at least a portion of the oxygenate into an ether to form an ether rich output fuel, and wherein the dehydration catalyst device is configured to provide the output fuel to the fuel injection system.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 illustrates a fuel system implemented in accordance with an embodiment of the invention.

FIG. 2 is a graph presenting experimental results of catalytic dehydration of the ethanol in 91 ON gasoline where the gasoline is exposed to H-Ferrierite (SiO₂/Al₂O₃=55).

FIG. 3 is a graph presenting experimental results of catalytic dehydration of the ethanol in 91 ON gasoline where the gasoline is exposed to H-ZSM-5 (SiO₂/Al₂O₃=80).

FIG. 4 is a graph presenting experimental results of catalytic dehydration of the ethanol in 91 ON gasoline where the gasoline is exposed to H-Beta (SiO₂/Al₂O₃=80).

FIG. 5 illustrates a fuel system having an ether storage module in accordance with an embodiment of the invention.

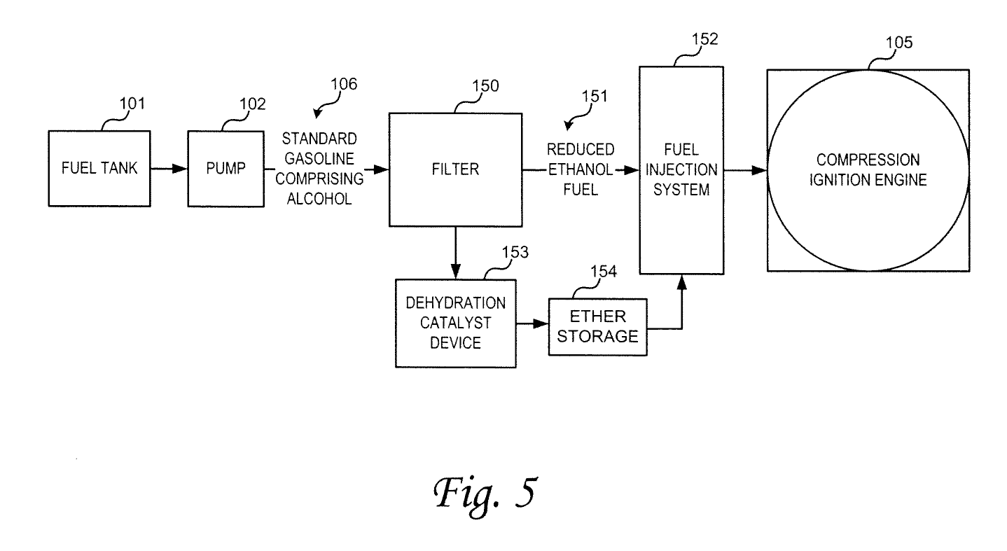

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

The present invention is directed toward a system and method for processing standard pump gasoline in an automotive fuel system to form an ether rich gasoline. The ether rich gasoline comprises the standard pump gasoline with at least a portion of the oxygenate content of the gasoline dehydrated into ether.

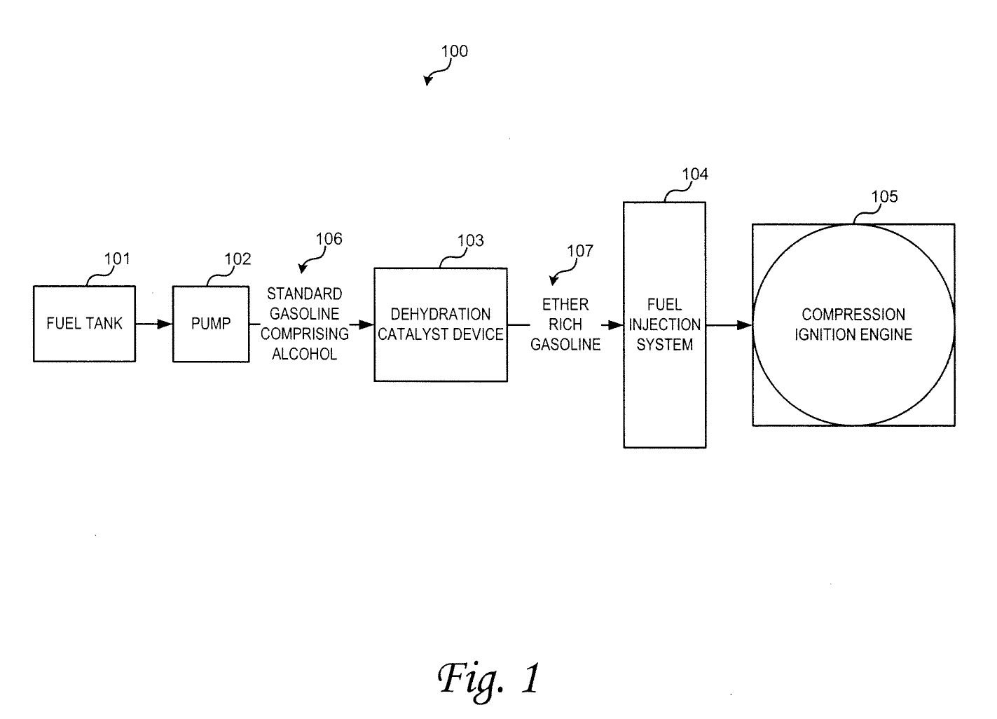

FIG. 1 depicts a fuel system implemented in accordance with an embodiment of the invention. The fuel system 100 is configured to supply fuel to an engine 105 that is configured to operate in a compression ignition mode for at least a portion of its operating range. Fuel system 100 comprises a fuel tank 101 configured to store standard gasoline 106.

As used herein, the term gasoline refers to a petroleum derived liquid mixture taken from approximately 200° C. and below during distillation and blended from the variety of chemical processes that are typically performed in the oil industry and includes additional standard chemical additives such as an oxygenate compound. Particularly, in some embodiments, the gasoline 106 comprises an alcohol such as ethanol or methanol. For example, standard gasoline 106 may comprise “pump” gasoline, such as standard 91 ON, 89 ON, 87 ON, or 85 ON pump gasoline. Further, gasoline 106 may comprise a standard hydrocarbon gasoline having up to 10 vol. % ethanol. Here, ON refers to the Anti-Knock Index rating number equal to the average between the Research Octane number (RON) and Motor Octane number (MON), where ON=(RON+MON)/2.

During operation of engine 105, a fuel pump 102 is connected in fluid communication to the tank 101 and a dehydration catalyst device 103. The fuel pump 102 pumps standard gasoline 106 from tank 101 through a dehydration catalyst device 103. As fuel 106 flows through the dehydration catalyst device 103, its alcohol content is at least partially converted into an ether to form ether rich gasoline output fuel 107. Ether rich output fuel 107 is then delivered to the fuel injection system 104, which is in fluid communication with the dehydration catalyst device 103. The fuel injection system 104 then meters fuel into the compression ignition engine 105.

In another embodiment, the tank 101 is configured to store a standard alcohol fuel, such as the E85 ethanol gasoline blended fuel. When an alcohol fuel is used, the oxygenate (i.e. ether) is the primary component of the fuel. In this embodiment, the fuel pump 101 pumps the alcohol fuel from tank 101 through the dehydration catalyst device 103 to create an ether rich output fuel. The ether rich output fuel 107 is then delivered to the fuel injection system 104 and metered into the compression ignition engine 105. In some embodiments, the fuel system is configured to operate on both gasoline fuels and alcohol fuels. In other embodiments, the fuel system may be configured to operate only with gasoline fuel or only with alcohol fuel.

In some embodiments, the dehydration catalyst device 103 comprises a chemical reactor comprising an acidic catalyst. The acidic catalyst may comprise a solid acid catalyst, a liquid acid catalyst, or a pseudo liquid/solid catalyst. In further embodiments, the catalyst comprises an aluminosilicate catalyst such as a zeolite. In particular embodiments, the catalyst comprises an H-Ferrierite, H-ZSM-5, H-Beta, or H-SAPO-34 catalyst. In other embodiments, the catalyst comprises Alumina, modified Aluminas i.e. Halide treated Alumina, Silica-Alumina, Metal-Modified Zeolites i.e. Sodium modified ZSM-5, Metal substituted zeolites i.e. Boron incorporated ZSM-5, Silicoaluminum Phosphates i.e. SAPO-34, Modified Silicoaluminum Phosphates i.e. Cobalt doped SAPO-34, Aluminum Phosphates i.e. ALPO-18, Modified Aluminum Phosphates i.e. Cobalt incorporated ALPO-18, Acidic Mesoporous Materials i.e. Si-MCM-41, Ion exchange resins i.e. Nafion, Polysulfonated resins i.e. Amberlyst 15, Solid Phosphoric Acid, Supported Mineral Acids i.e. Boric acid on diatomaceous earth, Heteropoly acids i.e. Silicotungstic acid, Supported Heteropoly acids i.e. Silicotungstic acid on SBA-15, Sulfonated Zirconia, Metal Oxides, Mixed Metal Oxides i.e. Titanium dioxide-Zirconium dioxide, Supported acids i.e. Antimony Pentafluoride on Silica-Alumina, Pillared Interlayered Clays, or Liquid Catalysts i.e. Sulfuric Acid, or combinations thereof.

As the fuel 106 passes through the dehydration device 103, at least a portion of the alcohol content of the gasoline undergoes a dehydration reaction to form an ether and water. For example, in the case of ethanol (CH₃CH₂OH), at least some of the ethanol in the gasoline 106 is used to produce diethyl ether through the reaction:

2CH₃CH₂OH→CH₃CH₂OCH₂CH₃+H₂O.

The dehydration of ethanol can also result in the production of ethylene as an elimination product through the reaction:

CH₃CH₂OH→C₂H₄+H₂O.

The cetane number (CN) of diethyl ether is significantly larger (approximately >85 CN) than the CN of ethanol, and correspondingly, the ON is significantly lower. However, the ignition characteristics of ethylene are similar to ethanol. These dehydration reactions are also reversible.

The composition of ether-rich output gasoline 107 is dependent on various properties of the dehydration catalyst device 103. For example, important process variables include the temperature at which the device is operated, the volume of the device, the pressure, chemical concentrations, heat transfer coefficients, catalytic materials used in the device, and catalyst surface area. Also, a fuel's ability to be compression ignited varies according to various engine properties, such as air/fuel ratio, load, and engine temperature.

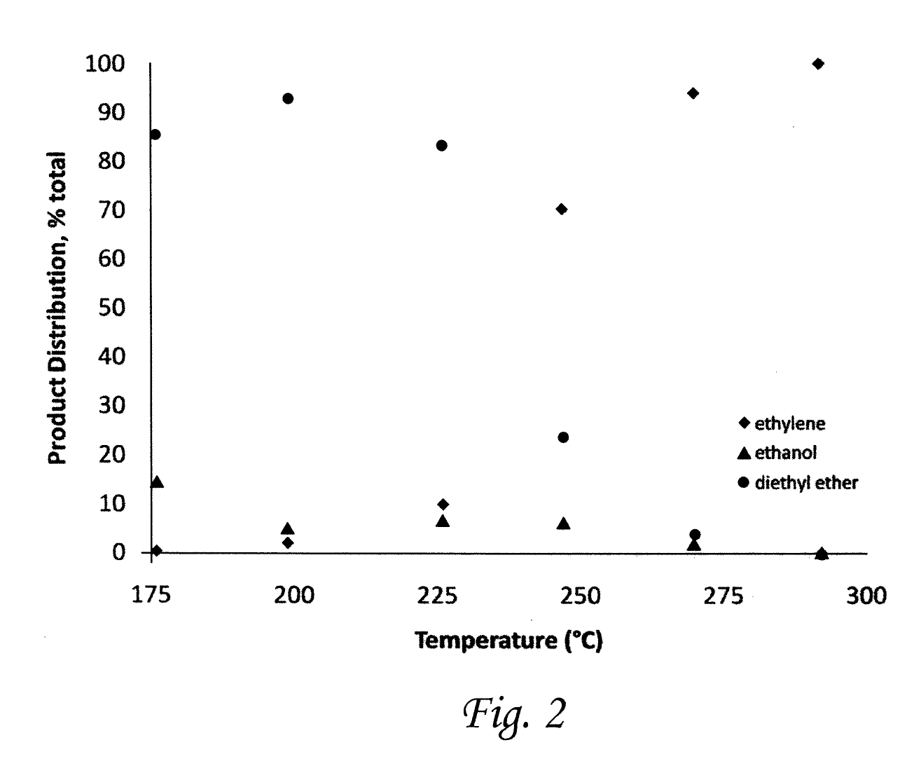

Various embodiments of the invention perform dehydration of alcohol or other oxygenate in standard gasoline using acidic catalysts. FIGS. 2-4 illustrate various reaction product distributions using different aluminosilicate catalysts. The tests were performed by exposing 91 ON gasoline to a variety of zeolite catalysts. The results were determined using a flame ionization detector in gas chromatography (GC-FID) with appropriate correction factors.

FIG. 2 illustrates the product distribution formed by exposing 91 ON gasoline to H-Ferrierite (SiO₂/Al₂O₃=55). The tests were performed under varying temperatures in a reactor at 15.9 MPa pressure with a 33.3 h⁻¹ weight hourly space velocity (WHSV). As these results show, ether production is maximized at around 200° C., with more than 90% of the originally present ethanol in the 91 ON gasoline being converted into diethyl ether. Furthermore, diethyl ether production shows a sharp decrease between 225° C. and 250° C. At around 250° C., ethylene becomes the dominate product of the catalytic reactor.

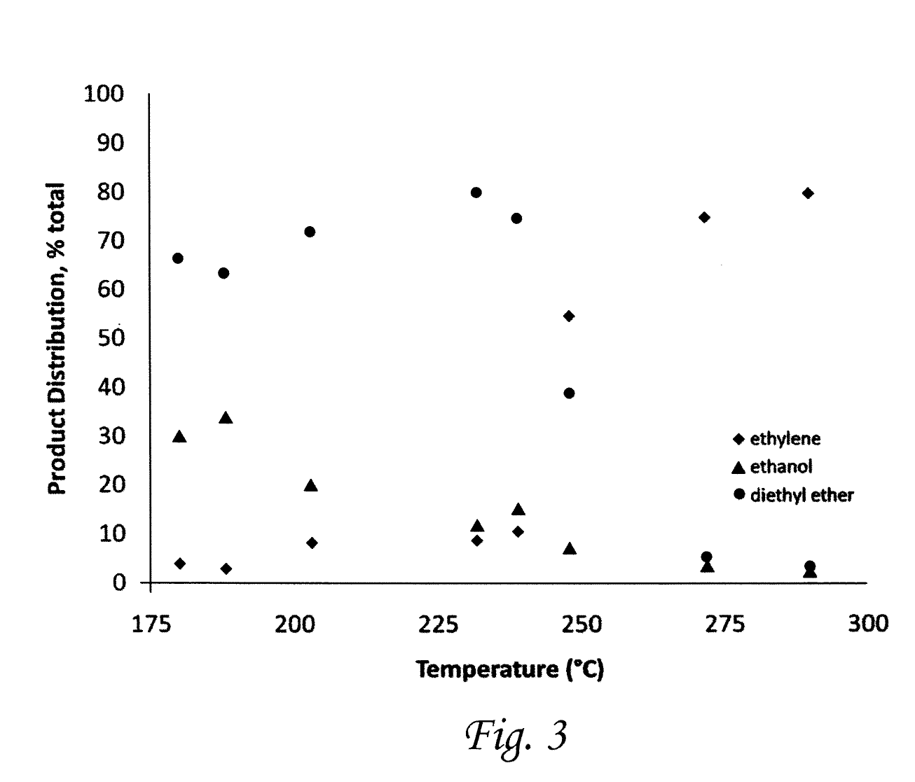

FIG. 3 illustrates the product distribution formed by exposing 91 ON gasoline to H-ZSM-5 (Zeolite Socony Mobil #5) (SiO₂/Al₂O₃=80). The tests were performed under varying temperatures in a reactor at 15.9 MPa and 28.6 h⁻¹ WHSV. As these results show, ether production is maximized between 200° C. and 230° C., with more than 80% of the originally present ethanol in the 91 ON gasoline being converted into diethyl ether. Similar to H-Ferrierite, diethyl ether production shows a sharp decrease near 250° C. At around 250° C., ethylene becomes the dominant product of the catalytic reactor.

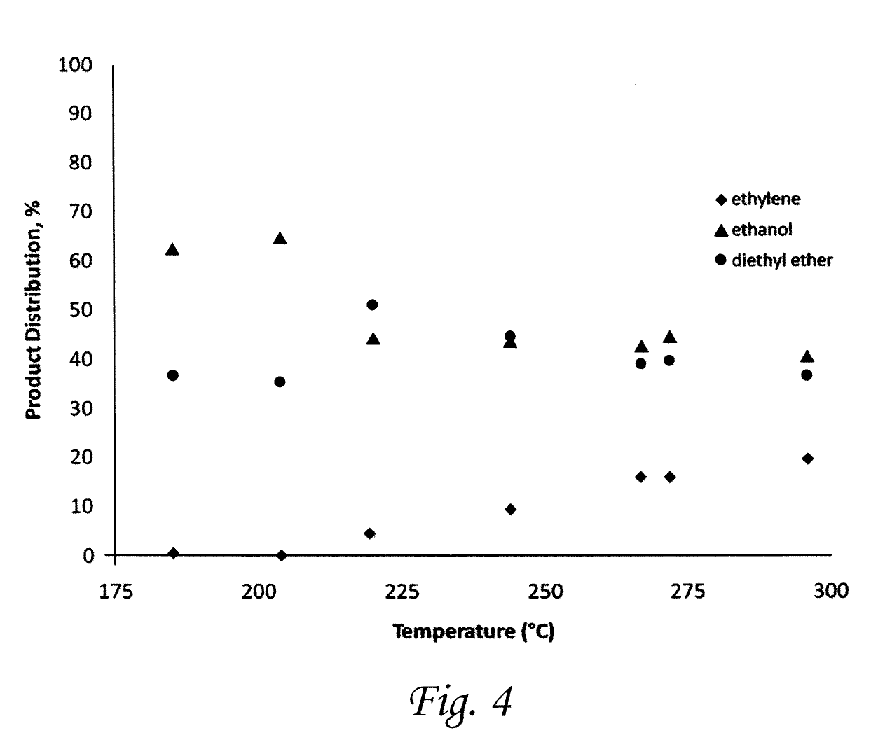

FIG. 4 illustrates the product distribution formed by exposing 91 ON gasoline to H-Beta (SiO₂/Al₂O₃=80). The tests were performed under varying temperatures in a reactor at 15.9 MPa and 28.6 h⁻¹ WHSV. In this reactor, ether production was maximized at around 220° C., with approximately 50% of the ethanol being converted into diethyl ether. However, unlike the reactors described with respect to FIGS. 2 and 3, the ether production was more constant throughout the range of temperatures from 175° C. to 300° C.

In compression ignition engines, the desirability of having lower octane or more ignitable fuels can change based on various engine parameters. For example, when the compression ignition engine 105 is operating in low load conditions with high air to fuel ratios, it may benefit more from large ether amounts in fuel 107 than when it is operating under high load conditions. For example, as the air-to-fuel mixture decreases, the fuel charge may be more easily compression ignited. As another example, compression ignition engine 105 may be configured to operate in a spark ignition mode under certain load conditions, such that the fuel 107 is not required to be as rich in ether under spark ignition. Accordingly, in one embodiment, the dehydration catalyst device 103 is configured to provide a maximum ether content in fuel 107 under low load conditions. In some embodiments, this may comprise modifying the temperature of the device 103, for example using heat sinks or heaters. In further embodiments, the catalyst material is chosen according to providing a predetermined ether percentage. The reactor volume of device 103 may also be configured according to the desired properties of output fuel 107. For example, the volume may be the WHSV of the catalyst chosen such that the reactor is able to meet the fuel consumption requirements of engine 105 under a predetermined operating condition or a predetermined range of operating conditions. In one embodiment, the reactor volume for device 103 is configured to provide at least a sufficient volume to enable a steady state catalytic reaction for the fuel consumption rate of engine 105 under a predetermined low load operating fuel to air mixture.

In the illustrated embodiment, the above described catalyst device eliminates any need to separate the ethanol out of fuel 106 before chemical conversion into fuel 107. Furthermore, the described processes allow standard pump gasoline to be used in a compression ignition engine without additional fuel additives. As such, it is not necessary to add additional water to fuel 107 over what is present from the dehydration of the ethanol into diethyl ether or ethylene.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A fuel system for an automotive engine, comprising:
a dehydration catalyst device in fluid communication with a fuel injection system and a fuel tank;
wherein the fuel tank is configured to store a fuel having an oxygenate;
wherein the dehydration catalyst device is configured to receive the fuel from the fuel tank;
wherein the dehydration catalyst device is configured to dehydrate at least a portion of the oxygenate into an ether to form an output fuel; and
wherein the dehydration catalyst device is configured to provide the output fuel to the fuel injection system.

2. The fuel system of claim 1, wherein the dehydration catalyst device is configured such that the portion of oxygenate dehydrated into the ether is sufficient to allow the output fuel to be used in a compression ignition engine at a predetermined engine load.

3. The fuel system of claim 2, wherein the dehydration catalyst device is configured such that the output fuel is usable in the compression ignition engine over a range of predetermined engine loads.

4. The fuel system of claim 2, wherein the dehydration catalyst device has a predetermined volume configured such that the portion of oxygenate dehydrated into the ether is sufficient to allow the output fuel to be used in a compression ignition engine at a predetermined load condition.

5. The fuel system of claim 1, further comprising a fuel pump disposed between the fuel tank and the dehydration catalyst device and configured to maintain a predetermined fuel pressure in the dehydration catalyst device.

6. The fuel system of claim 1, wherein the fuel comprises a gasoline fuel having an octane rating between 91 ON and 85 ON or wherein the fuel comprises an alcohol fuel, and wherein the oxygenate comprises ethanol, and wherein the ether comprises diethyl ether.

7. The fuel system of claim 1, wherein the dehydration catalyst device comprises an acidic catalyst.

8. The fuel system of claim 7, wherein the acidic catalyst comprises an alumina catalyst.

9. The fuel system of claim 8, wherein the acidic catalyst comprises an aluminosilicate catalyst comprising a zeolite.

10. The fuel system of claim 9, wherein the zeolite comprises H-Ferrierite, H-ZSM-5, H-Mordenite, HY or H-Beta.

11. The fuel system of claim 7, wherein the acidic catalyst comprises alumina, modified alumina, halide treated alumina, silica-alumina, metal-modified zeolite, sodium modified ZSM-5, metal substituted zeolite, boron incorporated ZSM-5, silicoaluminum phosphate, SAPO-34, modified silicoaluminum phosphate, cobalt doped SAPO-34, aluminum phosphates, ALPO-18, modified aluminum phosphates, cobalt incorporated ALPO-18, acidic mesoporous material, Si-MCM-41, ion exchange resin, Nafion, polysulfonated resins, Amberlyst 15, solid phosphoric acid, supported mineral acid, boric acid on diatomaceous earth, heteropoly acid, silicotungstic acid, supported heteropoly acids, silicotungstic acid on SBA-15, sulfonated zirconia, metal oxide, mixed metal oxide, titanium dioxide-zirconium dioxide, supported acid, antimony pentafluoride on silica-alumina, pillared interlayered clay, liquid catalyst, sulfuric acid, or combinations thereof.

12. The fuel system of claim 1, wherein the dehydration catalyst device is configured to be maintained at a predetermined operating temperature during engine operation.

13. A dehydration catalyst device, comprising:
a housing configured to be installed into a fuel system for an automotive engine; and
a catalyst disposed within the housing;
wherein, when installed in the fuel system:
the dehydration catalyst device is in fluid communication with a fuel injection system and a fuel tank;
the fuel tank is configured to store a fuel having an oxygenate;
the dehydration catalyst device is configured to receive the fuel from the fuel tank;
the dehydration catalyst device is configured to dehydrate at least a portion of the oxygenate into an ether to form an output fuel; and
the dehydration catalyst device is configured to provide the output fuel to the fuel injection system.

14. The dehydration catalyst device of claim 13, wherein the dehydration catalyst device is configured such that the portion of oxygenate dehydrated into the ether is sufficient to allow the output fuel to be used in a compression ignition engine at a predetermined load condition.

15. The dehydration catalyst device of claim 14, wherein the dehydration catalyst device is configured such that the output is usable in the compression ignition engine over a range of predetermined load conditions.

16. The dehydration catalyst device of claim 14, wherein the dehydration catalyst device has a predetermined volume configured such that the portion of oxygenate dehydrated into the ether is sufficient to allow the output fuel to be used in a compression ignition engine at a predetermined load condition.

17. The dehydration catalyst device of claim 13, further comprising a fuel pump disposed between the fuel tank and the dehydration catalyst device and configured to maintain a predetermined fuel pressure in the dehydration catalyst device.

18. The dehydration catalyst device of claim 13, wherein the fuel comprises a gasoline fuel having an octane rating between 91 ON and 85 ON or wherein the fuel comprises an alcohol fuel, and wherein the oxygenate comprises ethanol, and wherein the ether comprises diethyl ether.

19. The dehydration catalyst device of claim 13, wherein the dehydration catalyst device comprises an acidic catalyst.

20. The dehydration catalyst device of claim 19, wherein the acidic catalyst comprises an alumina catalyst.

21. The dehydration catalyst device of claim 20, wherein the acidic catalyst comprises an aluminosilicate catalyst comprises a zeolite.

22. The dehydration catalyst device of claim 21, wherein the zeolite comprises H-Ferrierite, H-ZSM-5, or H-Beta.

23. The dehydration catalyst device of claim 19, wherein the acidic catalyst comprises alumina, modified alumina, halide treated alumina, silica-alumina, metal-modified zeolite, sodium modified ZSM-5, metal substituted zeolite, boron incorporated ZSM-5, silicoaluminum phosphate, SAPO-34, modified silicoaluminum phosphate, cobalt doped SAPO-34, aluminum phosphates, ALPO-18, modified aluminum phosphates, cobalt incorporated ALPO-18, acidic mesoporous material, Si-MCM-41, ion exchange resin, Nafion, polysulfonated resins, Amberlyst 15, solid phosphoric acid, supported mineral acid, boric acid on diatomaceous earth, heteropoly acid, silicotungstic acid, supported heteropoly acids, silicotungstic acid on SBA-15, sulfonated zirconia, metal oxide, mixed metal oxide, titanium dioxide-zirconium dioxide, supported acid, antimony pentafluoride on silica-alumina, pillared interlayered clay, liquid catalyst, sulfuric acid, or combinations thereof.

24. The dehydration catalyst device of claim 13, wherein the dehydration catalyst device is configured to be maintained at a predetermined operating temperature during engine operation.

25. The dehydration catalyst device of claim 23, wherein the housing further comprises a heater.
